(19) United States
(12) Patent Application Publication
(10) Pub. No.: US 2023/0335001 A1
(43) Pub. Date: Oct. 19, 2023

(54) Document Processing Method, Information Processing Device, And Computer Program Product

(71) Applicant: LegalOn Technologies, Inc., Tokyo (JP)

(72) Inventor: Takashi KAWATO, Tokyo (JP)

(21) Appl. No.: 18/339,493

(22) Filed: Jun. 22, 2023

Related U.S. Application Data
(63) Continuation of application No. PCT/JP2020/048531, filed on Dec. 24, 2020.

(51) Int. Cl. G09B 7/02; G06F 40/166

(52) U.S. Cl. CPC G09B 7/02; G06F 40/166

(57) ABSTRACT

A document processing method is provided for causing a processor to execute a process. The document processing method includes: generating questionnaire information including a region where text can be freely input as an answer based on document information and question information, the question information being associated with at least one of a type and a situation of the document information and being for use in acquiring information for reviewing the document information; and generating request information for requesting a review of the document information, the request information including the document information and the questionnaire information in association with each other.

### CROSS-REFERENCE TO RELATED APPLICATIONS

This application is a continuation of International Application No. PCT/JP2020/048531, filed on Dec. 24, 2020, which designates the United States, and the entire contents of which are incorporated herein by reference.

### FIELD

Embodiments described herein relate generally to a document processing method, an information processing device, and a computer program product.

### BACKGROUND

Conventionally, an information processing device for creating a legal document on the basis of work performed by multiple people has been developed. For example, see Japanese Patent No. 6706637.

The information processing device disclosed in Japanese Patent No. 6706637 includes a document reception module that receives document information from a requester and that stores the received document information in a storage unit such that both requester and assignee can view the document information, a chat control module that controls the input and output of a conversation between the requester and the assignee, a control module that controls the input and output of comments on a part of the document information by the requester and the assignee, and a display control module that controls the display of the content of document information, the content of conversation, and the comments on one screen. Because the contents of chat and comments made on the document information are displayed on both sides of the requester and the assignee, the requester and assignee can exchange opinions on each document unit or each range in the document, thereby allowing both requester and assignee to edit the document information. Hence, it is possible to create a legal document on the basis of work performed by multiple people.

### SUMMARY

According to an aspect of an embodiment, a document processing method includes generating questionnaire information including a free description box (or a free comment box) that is a region, an area, or a space in which text or a comment can be freely input by a user as an answer based on document information and question information, the question information being associated with at least one of a type and a situation of the document information and being for use in acquiring information to be used for reviewing the document information; and generating request information to be used for requesting a review of the document information, the request information including the document information and the questionnaire information in association with each other.

### BRIEF DESCRIPTION OF THE DRAWINGS

FIG. 1 is a schematic diagram illustrating an example of a configuration of a document processing system according to an embodiment;

1] FIG. 2 is a block diagram illustrating a configuration example of a document processing server device according to the embodiment;

2] FIG. 3 is a schematic diagram illustrating a configuration example of document information;

3] FIG. 4 is a schematic diagram illustrating a configuration example of unit information;

4] FIG. 5 is a schematic diagram illustrating a configuration example of question information;

5] FIG. 6 is a schematic diagram illustrating a configuration example of questionnaire information and answer information;

6] FIG. 7 is a schematic diagram illustrating an example of a screen displayed on a display unit of a terminal when a type and a position are received;

7] FIG. 8 is a schematic diagram for explaining a questionnaire generation operation;

8] FIG. 9 is a schematic diagram illustrating an example of a screen displayed on a display unit of a terminal based on questionnaire information;

9] FIG. 10 is a schematic diagram illustrating an example of a screen displayed on a display unit of a terminal based on answer information; and

10] FIG. 11 is a flowchart illustrating an operation example of a document processing server device 1.

### DETAILED DESCRIPTION

Hereinafter, an embodiment of the present disclosure will be described in detail with reference to the accompanying drawings. Note that the present invention is not limited to the following embodiment.

### Configuration of Document Processing System

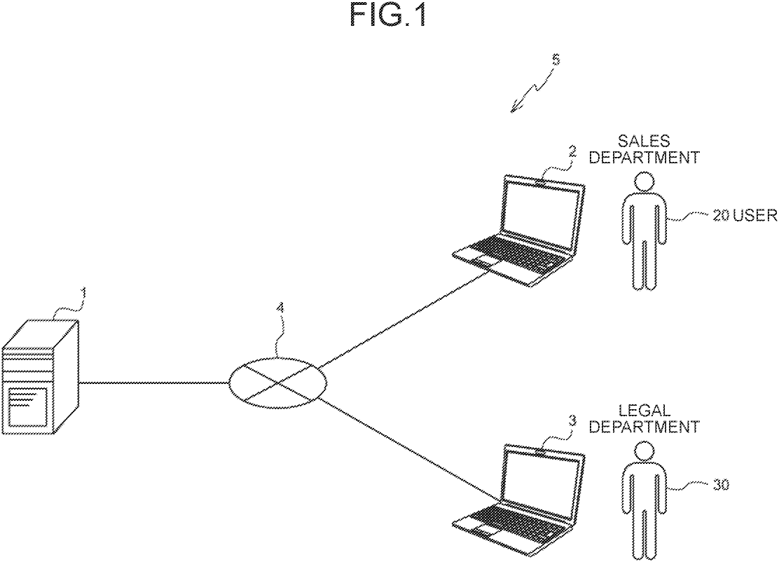

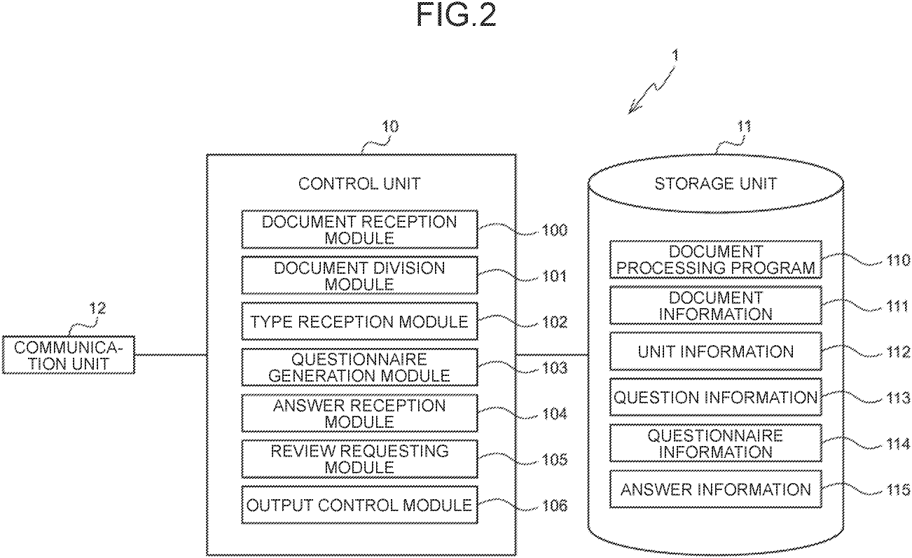

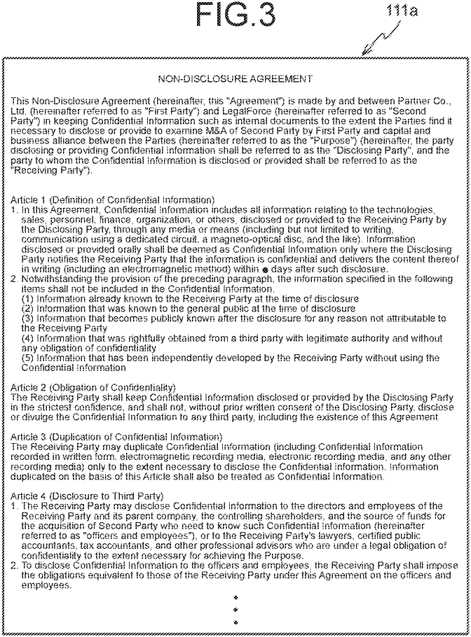

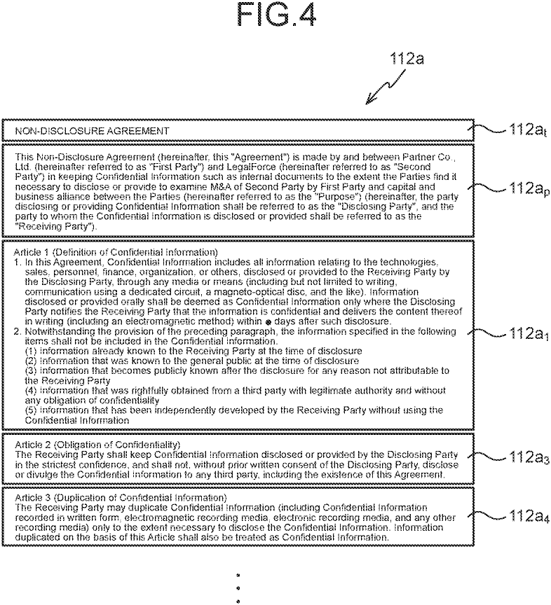

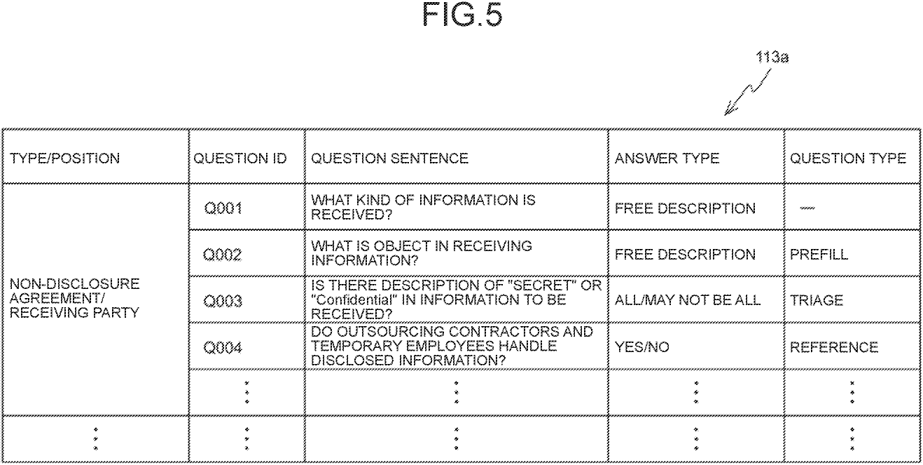

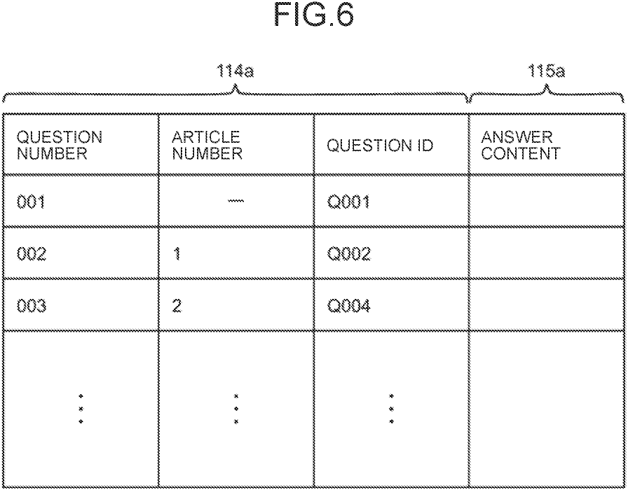

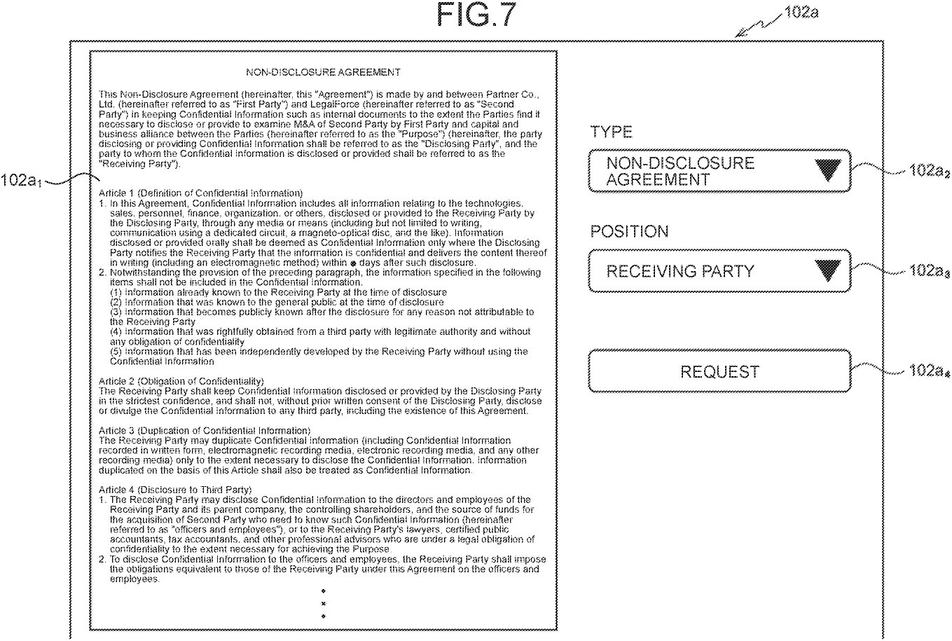

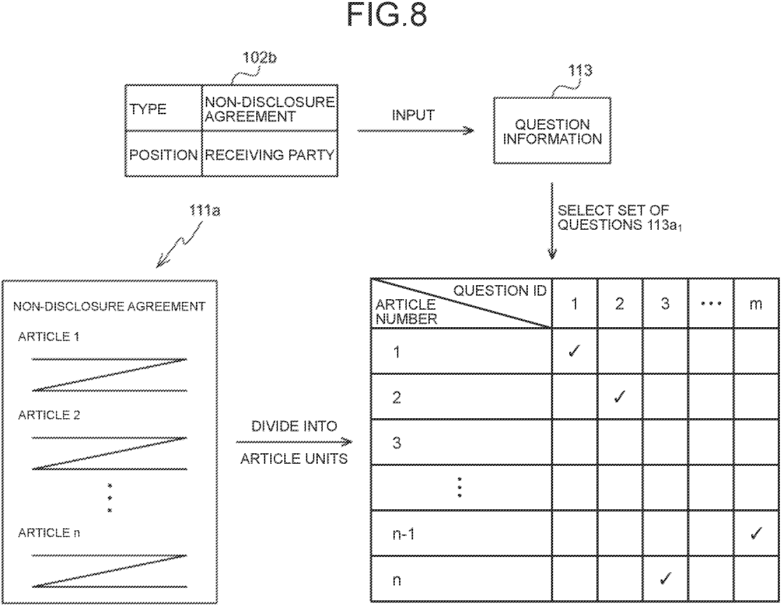

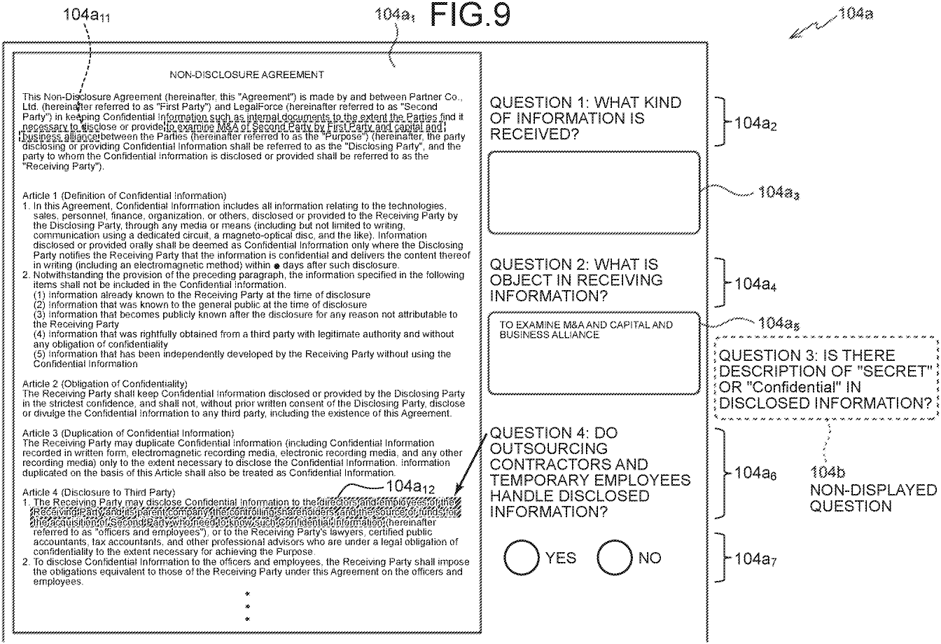

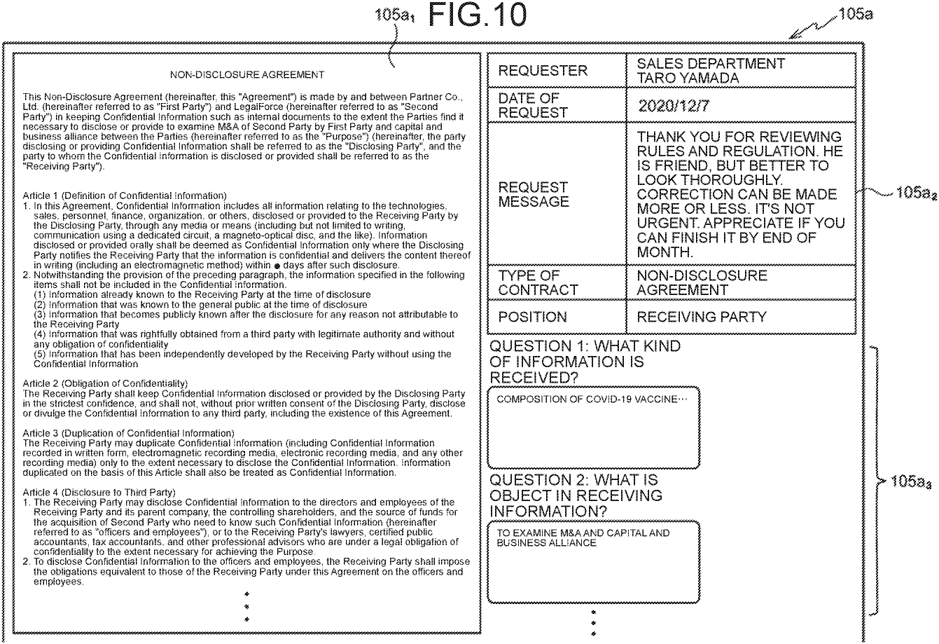

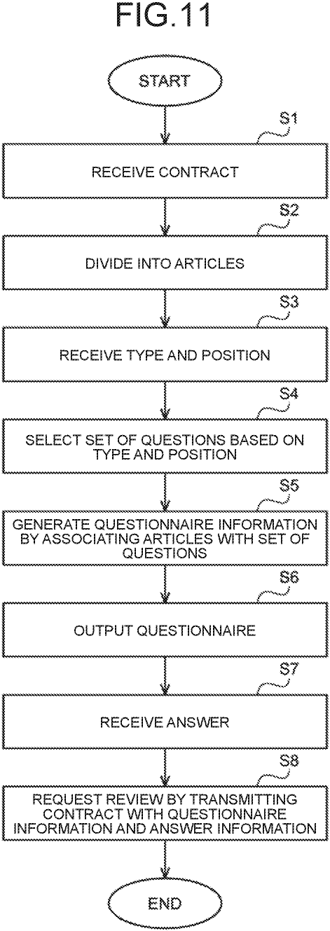

FIG. 1 is a schematic diagram illustrating an example of a configuration of a document processing system according to an embodiment.

In a document processing system 5, a document processing server device 1, a terminal 2, and a terminal 3 may be communicably connected with each other via a network 4. For example, the terminal 2 may be operated by a user 20 (for example, belonging to the sales department) who wishes to manage a document, create a document, confirm the content of a document, and/or review a document, and the terminal 3 is operated by a user 30 (for example, belonging to the legal department) who is asked to confirm the content of a document and/or review a document. For example, the user 20 of the terminal 2 and the user 30 of the terminal 3 deal with a contract as document information and confirm the contents of the contract, and mainly use the document processing system 5 to manage the document information created by one or both of the users 20 and 30, and to review the document information.

The document processing server device 1 may be a server-type information processing device, and may be operated in response to a request from the terminal 2 and the terminal 3. The main body of the document processing server device 1 may include electronic components such as a Central Processing Unit (CPU) having functions for processing information, a hard disk drive (HDD), and a flash memory. The document processing server device 1 need not be composed of a single information processing device, but may be cooperatively operated by a plurality of the information processing devices, or may be operated by any cloud service. Moreover, the functions of the document processing server device 1 may be implemented within the terminal 2 and/or terminal 3.

The terminal 2 and terminal 3 may be information processing devices such as Personal Computers (PCs) and tablet terminals. The main body of the terminal 2 and terminal 3 may include electronic components such as a CPU having functions for processing information and a flash memory.

The network 4 may be a communication network capable of high-speed communication. For example, the network 4 may be a wired or wireless communication network such as the Internet, an intranet, and a Local Area Network (LAN) .

In the above configuration, a document to be processed by the document processing server device 1 may be a document in the legal field such as a contract. In the following embodiment, the user 20 may be a person who is not a legal expert but need to draft a contract (person who belongs to the sales department and need to enter into a contract with outside). The user 30 may be a person who deals with law and have a knowledge of creating a contract (person who belongs to the legal department and manages the contracts of the sales department).

The user 20 may ask the user 30 to perform tasks such as confirming, examining, correcting, and making suggestions (review) on the content of document information, by first uploading the document information from the terminal 2 or terminal 3 to the document processing server device 1 on the basis of the operation of the user 20 or user 30, managing the document information in the document processing server device 1, and accessing the document processing server device 1 from the terminal 2. To reduce the workload of the user 30 to get confirmation with the user 20, or to support the user 30 in tasks such as examining, correcting, and making suggestions on the document information, the document processing server device 1 may generate a questionnaire for the user 20 on the basis of the content, type, position, and the like of the document information prior to the review request, make the user 20 to answer the questionnaire, and request a review by sending the questionnaire and answer content to the user 30. Hereinafter, the embodiment will be described.

In the drawing, the terminal 2 and terminal 3 are illustrated in a single form. However, a plurality of the terminals 2 and terminals 3 may be connected to the network 4. Similarly, the terminals 2 and terminals 3 may be operated by a plurality of users.

### Configuration of Document Processing Server Device

FIG. 2 is a block diagram illustrating a configuration example of the document processing server device 1 according to the embodiment.

The document processing server device 1 may include a control unit 10 that may have a CPU and the like, that may control each unit, and that may execute various computer programs; a storage unit 11 that may include a storage medium such as a flash memory and that may store information; and a communication unit 12 that may be used as a communication interface for communicating with the outside via the network 4.

The control unit 10 may include a processor such as a CPU, and may be electrically connected to the storage unit 11 including a memory, and the communication unit 12 that may be used as a communication interface. By executing a document processing program 110, which will be described below, the control unit 10 may be used as a document reception module 100, a document division module 101, a type reception module 102, a questionnaire generation module 103, an answer reception module 104, a review requesting module 105, an output control module 106, and the like.

For example, the document reception module 100 may receive a contract from the terminal 2 or terminal 3 as document information 111, and store the received document information in the storage unit 11. The document information 111 may be image information such as a Portable Document Format (PDF) in which text is laid out, or may be information such as a text file containing text data, and a Word format file. If the document information 111 is information other than text, the document reception module 100 may use Optical Character Recognition (OCR) or the like to convert the document information 111 into text.

The document division module 101 may divide the document information 111 into components of a contract such as a title, a preface, and article units, and store the components in the storage unit 11 as unit information 112. The article unit is not only a unit divided into articles, but may also be a unit divided into sections and items. The article unit may also be a collection of a plurality of provisions, sections, or items with coherent meaning. Moreover, the article unit may also be sections and items with coherent meaning across different provisions and sections. In the following, an article is sometimes referred to as a “clause”.

For example, when the user 20 asks the user 30 to review a contract, the type reception module 102 may receive an input of the type of the contract of the document information 111 to be reviewed, and a position with respect to the type, from the terminal 2. The type reception module 102 may also receive one of the type and the position, instead of receiving both the type and the position.

The questionnaire generation module 103 may select a corresponding set of questions from question information 113 on the basis of the type and the position (either information when one of the type and the position is received) received by the type reception module 102, edit the set of questions on the basis of the content of the document information 111 to be reviewed, and generate questionnaire information 114. The generated questionnaire information 114 may be output by the output control module 106, and displayed on a display unit of the terminal 2.

The answer reception module 104 may receive the answer of the user 20 to the questionnaire information 114 displayed on the display unit of the terminal 2, and store the received answer in the storage unit 11 as answer information 115.

The review requesting module 105 may display the document information 111 to be reviewed on a display unit of the terminal 3 along with the answer information 115 via the output control module 106, and ask the user 30 to review the document information 111.

The output control module 106 may output the document information 111, the unit information 112, the question information 113, the questionnaire information 114, and the answer information 115 in the storage unit 11 as well as the output results of the units 100 to 105 to the terminal 2 and the terminal 3 in a predetermined method, and the output information may be displayed on the display units of the terminal 2 and terminal 3. The details of the display method will be described below.

The storage unit 11 may include a memory such as a flash memory, and may be electrically connected to the control unit 10 including a processor or the like, and the communication unit 12 that used as a communication interface. The storage unit 11 may store the document processing program 110, the document information 111, the unit information 112, the question information 113, the questionnaire information 114, the answer information 115, and the like for operating the control unit 10 as each of the units 100 to 106 described above.

FIG. 3 is a schematic diagram illustrating a configuration example of the document information 111.

For example, document information 111a may be a contract, and include the contents agreed between the parties. The document information 111a may include a contract title, a preface, and contract clauses.

FIG. 4 is a schematic diagram illustrating a configuration example of the unit information 112.

Unit information 112a may include a contract title 112aₜ, a preface 112aₚ, and articles 112a₁, 112a₂, 112a₃, 112a₄, and the like.

FIG. 5 is a schematic diagram illustrating a configuration example of the question information 113.

Question information 113a may include type/position indicating a type of the contract and a position with respect to the contract, a question ID for identifying the question, a question sentence indicating the content of the question, an answer type indicating the type when an answer to the question sentence is received, and a question type indicating a type of displaying the question. The question may include a set of questions (question IDs “Q001”, “Q002”, “Q003”, “Q004”, and the like) for each type/position.

For example, the answer type described above may include “free description (or free comment)” (box) that is a region, an area, or a space in which text or a comment can be freely input as an answer, “all/may not be all” where either “all” or “may not be all” is selected as an answer, and “Yes/No” where either “Yes” or “No” may be selected as an answer. However, the answer content may vary.

For example, the question type described above may include “Prefill” in which the corresponding content may be extracted from the unit information 112 and may be input in advance in the answer field, “Triage” that may be a question not selected when there may be no need to ask question according to the content of the unit information 112, and “Reference” in which the content corresponding to the question may be extracted from the unit information 112 and may be referred to. The details will be described in FIG. 9.

FIG. 6 is a schematic diagram illustrating a configuration example of the questionnaire information 114 and the answer information 115.

Questionnaire information 114a may include a question number to identify the question, an article number of the article corresponding to the question, and a question ID corresponding to the question ID of the question information 113. Answer information 115a may include the answer content corresponding to the questionnaire information 114a.

### Operation of Document Processing System

Next, an operation of the embodiment will be described. Hereinafter, an operation is described by setting the terminal 2 as an object to be operated. When the same operation is performed even if the object to be operated is switched to the terminal 3, the description thereof will be omitted.

### Basic Operation

First, the user 20 may operate the terminal 2 to login to the service provided by the document processing server device 1. Upon receiving an input of information such as a user ID and password from the user 20, the terminal 2 may transmit an authentication request to the document processing server device 1 along with the information.

Upon receiving the authentication request from the terminal 2 along with the information such as the user ID and password, the document processing server device 1 may refer to the user information, including the user ID, password, and the like registered in advance, and authenticates the user as a user.

Next, after having logged into the service, the user 20 may operate the terminal 2 to upload the document information of the contract and the amended document information, to the document processing server device 1. The terminal 2 may upload the document information to the document processing server device 1.

### Questionnaire Generation Operation

FIG. 11 is a flowchart illustrating an operation example of the document processing server device 1.

The document reception module 100 of the document processing server device 1 may receive the document information 111 corresponding to the original contract or the addendum from the terminal 2 operated by the user, and may store the received document information 111 in the storage unit 11 (S1) .

Next, the document division module 101 of the document processing server device 1 may divide the document information 111 into components of the contract serving as the unit information 112 (S2). For example, the document information 111 may be text data or data created using word processing software. However, the document information 111 may also be image information such as a Portable Document Format (PDF) file including a scanned contract. When the document information 111 is scanned data, the document division module 101 may first convert the document information 111 into text using a method such as Optical Character Reader (OCR). Next, the document division module 101 may divide the text-converted information into a contract title, a preface, article units, section units, and the like. The document division module 101 may also divide the target document information 111 into units of items. Units suitable for the structure of the document information 111 may be used as the unit information 112. The division described above may be performed using techniques such as machine learning or regular expressions.

Next, the user 20 may operate the terminal 2 to ask the user 30 to review a contract. The terminal 2 may request to start a review request.

Next, the type reception module 102 of the document processing server device 1 may display the following screen on the display unit of the terminal 2 via the output control module 106, to receive an input of the type of the contract of the document information 111 to be reviewed and the position with respect to the type, from the terminal 2.

FIG. 7 is a schematic diagram illustrating an example of a screen displayed on a display unit of the terminal 2 when the type and the position are received.

A screen 102a may include a contract display field 102a₁ where the content of the document information 111 is displayed, a type selection field 102a₂ where the type of the contract is selected, a position selection field 102a₃ where the position with respect to the contract is selected, and a requesting button 102a₄ for starting the request.

For example, the user 20 may select “Non-Disclosure Agreement” from the candidates displayed in the type selection field 102a₂, and “Receiving Party” from the candidates displayed in the position selection field 102a₃.

The type reception module 102 of the document processing server device 1 may receive an input of “Non-Disclosure Agreement” that is the type of the contract of the document information 111 to be reviewed, and “Receiving Party” that is the position with respect to the type, from the terminal 2 (S3), for example.

FIG. 8 is a schematic diagram for explaining a questionnaire generation operation.

Next, as illustrated in FIG. 8, the questionnaire generation module 103 may input the type and position 102b received by the type reception module 102, and select a corresponding set of questions 113a₁ from the question information 113 including a plurality of sets of questions (S4). The questionnaire generation module 103 may also generate questionnaire information 114 by associating each question in the set of questions 113a₁ with the content of the document information 111 to be reviewed that may be divided into articles by the document division module 101 (S5) .

For example, the questionnaire generation module 103 may generate a learning model by learning the content of each article using teacher data prepared in advance in which a question is labeled, and the association is performed using the learning model. As a result of association, the order of questions may be rearranged according to the article, and there may be a question that cannot be associated with the content.

The generated questionnaire information 114 may be displayed on the display unit of the terminal 2 by the output control module 106 as illustrated in FIG. 9 (S6).

FIG. 9 is a schematic diagram illustrating an example of a screen displayed on a display unit of the terminal 2 based on the questionnaire information 114.

A screen 104a may include a contract display field 104a₁ where the content of the document information 111 may be displayed, questions 104a₂, 104a₄, and 104a₆, and answer fields 104a₃, 104a₅, and 104a₇.

The answer type of the question 104a₂ may be “free description” in the question information 113a illustrated in FIG. 5. Hence, a free description field may be prepared as the answer field 104a₃.

Moreover, the answer type of the question 104a₄ may be “free description” and the question type may be “Prefill” in the question information 113a illustrated in FIG. 5. Hence, a free description field may be prepared as the answer field 104a₅, and text of the extracted prefill part 104a₁₁ may be input (prefilled) in advance. For example, for each contract type, learning may be performed using teacher data prepared in advance in which a part that may be an answer to the question is labeled with the content of each article or the like, and the extraction operation may be performed using a learning model obtained as a learning result. The extraction operation may also be performed using other methods.

Moreover, the answer type of the question 104a₆ may be “Yes/No” and the question type may be “Reference” in the question information 113a illustrated in FIG. 5. Hence, selection buttons of “Yes” and “No” may be prepared as the answer field 104a₇, and a reference part 104a₁₂ that is the content corresponding to the question may be referred to. For example, for each contract type, learning may be performed using teacher data prepared in advance in which a part relating to the question is labeled with the content of each article and the like, and the reference operation may be performed using a learning model obtained as a learning result. The reference operation may also be performed using other methods.

Moreover, the question type of a non-displayed question 104b may be “Triage” in the question information 113a illustrated in FIG. 5. As it is determined that there is no need to ask question according to the content of the unit information 112, the non-displayed question 104b may not be displayed on the screen 104a. For example, for each contract type, learning may be performed using teacher data prepared in advance in which a part determined that there may be no need to ask question is labeled with the content of each article and the like, and the determination may be performed using a learning model obtained as a learning result. The determination may also be performed using other methods.

In the screen 104a described above, the question type of each question may be one of the “Prefill”, “Reference” and “Triage”. However, the question type may also be a plurality of the “Prefill”, “Reference”, and “Triage”. For example, the question type of a question may be “Prefill” and “Triage”, and the question type of a question may be “Prefill” and “Reference”.

Moreover, in the screen 104a described above, “Question 3” may not be displayed as the non-displayed question 104b. However, as a result of the question type “Triage”, a list of non-displayed questions may be displayed on the screen 104a (or by providing a link to the screen 104a) .

The user 20 may confirm the content of the screen 104a on the display unit of the terminal 2, operate the operation panel, and input information into the answer fields 104a₃, 104a₅, and 104a₇.

The terminal 2 may request a review by sending the information input in the answer fields 104a₃, 104a₅, and 104a₇ to the document processing server device 1.

The answer reception module 104 may receive the answer of the user 20 to the questionnaire information 114 displayed on the display unit of the terminal 2 (S7), and store the received answer in the storage unit 11 as the answer information 115.

### (3) Review Request Operation

Next, the review requesting module 105 may generate review requesting information from the document information 111 to be reviewed and the answer information 115. Then, as illustrated in the following FIG. 10, the review requesting module 105 in the document processing server device 1 may send information that causes the display unit of the terminal 3 to display a screen 105a via the output control module 106 to the terminal 3, and ask the user 30 to review the document information 111 (S8).

FIG. 10 is a schematic diagram illustrating an example of a screen displayed on the display unit of the terminal 2 based on the answer information 115.

The screen 105a may include a contract display field 105a₁ where the content of the document information 111 may be displayed, a request content display field 105a₂ where requesting contents such as a requester, date of request, request message, contract type, and position may be displayed, and an answer display field 105a₃ where the contents of the questionnaire information 114 and the answer information 115 to the questionnaire information 114 may be displayed.

The user 30 may confirm the contents of the request content display field 105a₂ and the answer display field 105a₃ on the screen 105a displayed on the display unit of the terminal 3, review the content of the request content display field 105a₂ on the basis of the contents, edit the content, and return the edited content to the user 20.

According to the embodiment described above, a set of questions may be selected from the question information 113 according to the type of the document information 111 and a position with respect to the document information 111, the questionnaire information 114 may be generated by associating the document information 111 with the unit information 112 that may be divided into units of articles, sections, items, and the like, the questionnaire information 114 may be presented to the user 20 who may be the review requester, and the user 30 who may be the review assignee may be asked to review the document information 111 with the answer information 115 serving as the answer of the user 20 to the questionnaire information 114. Hence, it is possible to suppress an increase in the burden on the assignee in transmitting information with the requester in reviewing the document information 111.

Moreover, the question types of “Prefill”, “Triage”, “Reference”, or the like may be set for the question information 113, and in generating the questionnaire information 114, the answer content may be input in advance (Prefill), unnecessary question may not be presented (Triage), and the content indicated in the question may be specified (Reference). Hence, it is possible to suppress an increase in the number of processes required for the answer of the user 20 who may be the requester.

On the other hand, according to the information processing device disclosed in Japanese Patent No. 6706637 described above, although the contents of chat and comments made on the document information are displayed on both sides of the requester and the assignee, the assignee may need to examine the content of the document information and ask questions to the requester, thereby placing a heavy burden on the assignee in the process such as examining and correcting the document information.

The user-friendly computer program product, the information processing device, and the document processing method according to the embodiment described above can solve the above problem.

### Other Embodiments

Various modifications may be made without departing from the scope of the claimed invention.

For example, the document information 111 may be contracts, a law document itself or a document in the field other than law such as a user manual, which a review on the content of the document may be required to be requested. Moreover, the components may be articles, sections, or items, but may be words, letters, and symbols, or may be paragraphs and text. Furthermore, an embodiment may also be implemented without dividing the document information 111 into components. Still furthermore, the language of the document information 111 may be Japanese or English, and the document information 111 may be applicable to another language as long as the language can form a sentence from which information can be extracted.

For example, the document information 111 is not limited to contracts or agreements. The document information 111 may be any document such as a document whose contents are to be reviewed, e.g., a document reciting laws and regulations or a document of a different field other than the law such as a user’s manual. The present invention is also applicable to such documents. In addition, the document information 111 may be divided in units of words, letters, symbols, paragraphs, or text, in place of articles, sections, or items. Some embodiments in which the document information 111 is not divided in units may be implemented. The written language of the document information 111 may be any other language different from Japanese and English as long as information can be extracted from the sentences written in that language.

Still furthermore, in the embodiment described above, the document processing server device 1 is used as an information processing device. However, the processing executed by the document processing server device 1 and information stored in the document processing server device 1 may be distributed to other server devices, and the document processing server device 1 and the other server devices may be used as an information processing device in an integral manner. Still furthermore, the terminal 2 or terminal 3 may also be as an information processing device to perform each process.

Still furthermore, in the embodiment described above, the article unit may be mainly used as the division module of the document information, and the question may be associated by the article unit. However, the section unit and the item unit may also be used as the division module, or the question may be associated by a combination of the article unit, the section unit, and the item unit.

Still furthermore, in the embodiment described above, the questionnaire information 114 and the answer information 115 may be mainly output to the terminal 2 and terminal 3 via the communication unit of the document processing server device 1, and the questionnaire information 114 and the answer information 115 may be displayed on the display units of the terminal 2 and terminal 3. However, the contents of the questionnaire information 114 and the answer information 115 may be notified to the user by any method, and any method may be used. Still furthermore, if the terminal 2 or terminal 3 functions as a document processing device, an alert may be output to an external display, or may be output directly to the user’s display unit.

In the embodiment described above, the type reception module 102 may receive the type of the document information 111 and the position with respect to the document information 111 input from the terminal 2, and the questionnaire information 114 may be generated by the questionnaire generation module 103. For example, the type and the position can be received when the user selects the specific type and the position through the terminal 2. However, for example, when the document information 111 is input to the terminal 2, the document processing server device 1 or the terminal 2 may analyze the document information 111, determine the type and the position on the basis of the results, and receive the type and position determined by the type reception module 102.

In the embodiment described above, the units 100 to 106 of the control unit 10 may be implemented by a computer program. However, all or part of the units may also be implemented by hardware such as an application-specific integrated circuit (ASIC). Moreover, the computer program used in the embodiment described above may be provided by storing the computer program in a recording medium such as a compact disc read-only memory (CD-ROM). Furthermore, replacement, deletion, addition, and the like of the above-mentioned steps described in the above embodiments are possible within a range that does not change the gist of the present invention.

Provided are a document processing program, an information processing device, and a document processing method that suppress an increase in the burden on the assignee in transmitting information with the requester, when the assignee is asked to review document information.

According to various embodiments in the present disclosure, it is possible to provide a more user-friendly computer program product, an information processing device, and a document processing method.

For the embodiments described above, the following Notes are disclosed, as aspects and selective features of the inventions.

### Note. 1

According to an aspect of an embodiment, a computer program product includes a computer-readable medium including programmed instructions, and the instructions cause a computer to execute: acquiring, from question information in which at least one of questions and answer contents is prepared in advance in association with at least one of a type of document information and a position with respect to the document information, question information based on at least one of a type of document information and a position with respect to the document information that are received; dividing the received document information into predetermined units; selecting question information from the acquired question information in association with the corresponding unit; and generating questionnaire information.

### Note. 2

According to another aspect of an embodiment, an information processing device includes: a memory configured to store document information in addition to predetermined instructions; and a processor configured to: based on the instructions stored in the memory, acquire, from question information in which at least one of questions and answer contents is prepared in advance in association with at least one of a type of document information and a position with respect to the document information, question information based on at least one of a type of document information and a position with respect to the document information that are received; divide the received document information into predetermined units; select question information from the acquired question information in association with the corresponding unit; and generate questionnaire information.

### Note. 3

According to further another aspect of an embodiment, a document processing method includes: acquiring, from question information in which at least one of questions and answer contents is prepared in advance in association with at least one of a type of document information and a position with respect to the document information, question information based on at least one of a type of document information and a position with respect to the document information that are received; dividing the received document information into predetermined units; selecting question information from the acquired question information in association with the corresponding unit; and generating questionnaire information.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. All such modifications as would be apparent to one of ordinary skill in the art are intended to be included within the scope of the following claims. The accompanying claims and their equivalents are intended to cover such forms or modifications as would fall within the scope and spirit of the inventions.

What is claimed is:

1. A document processing method for causing a processor to execute a process, the document processing method comprising executing on the processor the steps of:
generating questionnaire information including a region where text can be freely input as an answer based on document information and question information, the question information being associated with at least one of a type and a situation of the document information and being for use in acquiring information for reviewing the document information; and
generating request information for requesting a review of the document information, the request information including the document information and the questionnaire information in association with each other.

2. The document processing method according to claim 1, further comprising:
receiving answer information responsive to the generated questionnaire information, and
issuing a request for the review of the document information in association with the answer information.

3. The document processing method according to claim 1, wherein
the questionnaire information includes a pre-input answer to the question information, and the pre-input answer is extracted from content of a unit of divisions of the document information.

4. The document processing method according to claim 1, wherein
the questionnaire information includes, as an answer, an option of referring to information responsive to a question in the question information and changing content of the question.

5. The document processing method according to claim 1, wherein
the questionnaire information includes no questions included in the question information.

6. The document processing method according to claim 1, wherein
the questionnaire information includes, as an answer, according to a question type predefined in the question information:
an option (a) for using a pre-input answer to the question information;
an option (b) for changing content of a question in the question information; and
an option (c) for providing no questions included in the question information.

7. The document processing method according to claim 1, wherein
the document processing method is executed by a computer connected communicably to one or more terminals via a network.

8. The document processing method according to claim 1, further comprising:
receiving answer information responsive to the generated questionnaire information; and
issuing a request for the review of the document information based on the questionnaire information and the answer information.

9. The document processing method according to claim 1, wherein
the document processing method is executed by a computer connected communicably to one or more terminals via a wireless communication network.

10. A document processing system comprising:
a memory configured to store a program; and
one or more processors configured to execute the program so as to:
generate questionnaire information including a region where text can be freely input as an answer based on document information and question information, the question information being associated with at least one of a type and a situation of the document information and being for use in acquiring information for reviewing the document information; and
generate request information for requesting a review of the document information, the request information including the document information and the questionnaire information in association with each other.

11. The document processing system according to claim 10, wherein
the one or more processors is configured to:
receive answer information responsive to the generated questionnaire information, and
issue a request for the review of the document information in association with the answer information.

12. The document processing system according to claim 10, wherein
the questionnaire information includes a pre-input answer to the question information, and the pre-input answer is extracted from content of a unit of divisions of the document information.

13. The document processing system according to claim 10, wherein
the questionnaire information includes, as an answer, an option of referring to information responsive to a question in the question information and changing content of the question.

14. The document processing system according to claim 10, wherein
the questionnaire information includes no questions included in the question information.

15. The document processing system according to claim 10, wherein
the questionnaire information includes, as an answer, according to a question type predefined in the question information:
an option (a) for using a pre-input answer to the question information;
an option (b) for changing content of a question in the question information; and
an option (c) for providing no questions included in the question information.

16. A computer program product embodying programmed instructions stored on a non-transitory computer readable medium for causing a computer to execute a process by a processor so as to perform the steps of:
generating questionnaire information including a region where text can be freely input as an answer based on document information and question information, the question information being associated with at least one of a type and a situation of the document information and being for use in acquiring information for reviewing the document information; and
generating request information for requesting a review of the document information, the request information including the document information and the questionnaire information in association with each other.

17. The computer program product according to claim 16, further comprising:
receiving answer information responsive to the generated questionnaire information, and
issuing a request for the review of the document information in association with the answer information.

18. The computer program product according to claim 16, wherein
the questionnaire information includes a pre-input answer to the question information, and the pre-input answer is extracted from content of a unit of divisions of the document information.

19. The computer program product according to claim 16, wherein
the questionnaire information includes, as an answer, an option of referring to information responsive to a question in the question information and changing content of the question.

20. The computer program product according to claim 16, wherein
the questionnaire information includes, as an answer, according to a question type predefined in the question information:
an option (a) for using a pre-input answer to the question information;
an option (b) for changing content of a question in the question information; and
an option (c) for providing no questions included in the question information.
